(19) United States
(12) Patent Application Publication
(10) Pub. No.: US 2025/0321981 A1
(43) Pub. Date: Oct. 16, 2025

(54) AUTOMATIC DATA CLASSIFICATION

(71) Applicant: Snowflake Inc., Bozeman, MT (US)

(72) Inventors: Ankit Gupta, Bellevue, WA (US); Yimeng Li, Bellevue, WA (US); Nabajyoti Patowary, Seattle, WA (US); Raghavendran Ramakrishnan, Kirkland, WA (US); Yanshu Zhao, Kirkland, WA (US)

(21) Appl. No.: 18/635,678

(22) Filed: Apr. 15, 2024

(51) Int. Cl. G06F 16/28; G06F 21/62

(52) U.S. Cl. CPC G06F 16/285; G06F 16/35; G06F 21/6218

(57) ABSTRACT

Systems and methods are provided for classifying data. The systems and methods access an automatic classification profile comprising one or more conditions for triggering data classification and access a classification scope that identifies one or more tables to be classified. The systems and methods determine that a set of attributes of the one or more tables identified by the classification scope corresponds to the one or more conditions of the automatic classification profile. The systems and methods, in response to determining that the set of attributes of the one or more tables identified by the classification scope corresponds to the one or more conditions of the automatic classification profile, automatically classify data stored in one or more columns of the one or more tables.

### TECHNICAL FIELD

Examples of the disclosure relate generally to data platforms and databases and, more specifically, to classifying data in tables.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Databases are used by various entities and companies for storing information that may need to be accessed or analyzed. Various operations performed on a database, such as joins and unions, involve combining query results obtained from different data sources (e.g., different tables, possibly on different databases) into a single query result. The various operations that can be performed on the databases are controlled based on access privileges of requesting entities.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based data platform, in accordance with some examples.

FIG. 2 is a block diagram illustrating components of a compute service manager, in accordance with some examples.

FIG. 3 is a block diagram illustrating components of an execution platform, in accordance with some examples.

FIG. 4 is a block diagram of a column classification manager, in accordance with some examples.

FIGS. 5 and 6 are illustrative outputs of the column classification manager, in accordance with some examples.

FIG. 7 is a flow diagram illustrating a method of the column classification manager, in accordance with some examples.

FIG. 8 illustrates a diagrammatic representation of a machine in the form of a computer system within which a set of instructions may be executed for causing the machine to perform any one or more of the methodologies discussed herein, in accordance with some examples.

### DETAILED DESCRIPTION

Reference will now be made in detail to specific examples for carrying out the inventive subject matter. These examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. The data platform may include one or more databases that are respectively maintained in association with any number of customer accounts, as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata in association with the data platform in general and in association with, as examples, particular databases and/or particular customer accounts as well. The database can include one or more objects, such as tables, functions, and so forth.

Users and/or executing processes that are associated with a given customer account may, via one or more types of clients, be able to cause data to be ingested into the database, and may also be able to manipulate the data, add additional data, remove data, run queries against the data, generate views of the data, and so forth. In an example implementation of a data platform, a given database is represented as an account-level object within a customer account, and the customer account may also include one or more other account-level objects such as users, roles, and/or the like. Furthermore, a given account-level database object may itself contain one or more objects such as tables, schemas, views, streams, tasks, and/or the like.

A given table may be organized as records (e.g., rows or a collection of rows) that each include one or more attributes (e.g., columns). A data platform may physically store database data in multiple storage units, which may be referred to as blocks, micro-partitions, and/or by one or more other names. In an example, a column of a database can be stored in a block and multiple blocks can be grouped into a single file. That is, a database can be organized into a set of files where each file includes a set of blocks. Consistent with this example, for a given column, all blocks are stored contiguously and blocks for different columns are row aligned. Data stored in each block can be compressed to reduce its size. A block storing compressed data may also be referred to as a “compression block” herein. As referred to herein, a “record” is defined as a collection of data (e.g., textual data) in a file that is organized by one or more fields, where each field can include one or more respective data portions (e.g., textual data, such as strings). Each field in the record can correspond to a row or column of data in a table that represents the records in the file. It should be understood that the terms “row” and “column” are used for illustration purposes and these terms are interchangeable. Data arranged in a column of a table can similarly be arranged in a row of the table.

In many cases, the columns of a table may need to be classified, such as to assign different category labels to the columns and/or the entire table. These category labels can assist with performing different operations on the columns and in the presentation of information stored in the columns. Conventional systems usually apply category rules to the entries of the columns to determine to which category a column belongs. These rules are usually predefined and do not scale well with large datasets.

Conventional systems can automatically classify data stored in the columns but require manual triggering by user accounts to perform such classification. The need for users to create and maintain custom pipelines to automate the classification of multiple tables introduces a considerable cognitive and financial burden. Users must invest time and effort into developing, testing, and deploying these pipelines, which can be complex and require specialized knowledge. As the data environment evolves and new requirements emerge, these pipelines must be updated, which further increases the maintenance overhead. This ongoing requirement for human intervention not only consumes valuable time that could be spent on more strategic tasks but also increases the likelihood of errors, which can be costly to rectify.

Moreover, the ad-hoc or periodic nature of running these pipelines can lead to increased time to detection of personally identifiable information (PII) or sensitive data. Since the pipelines are not continuously active, there can be significant delays between the introduction of new data and its classification. This lag creates windows of vulnerability where sensitive data may be exposed to unauthorized access or may not comply with data protection regulations, potentially leading to legal and reputational risks. Custom detection, review, and governance practices that users must implement due to the limitations of the current system further exacerbate the problem. These practices can vary widely between users, making it difficult to standardize processes and adopt industry best practices. The lack of standardization can lead to inconsistent data handling, inefficiencies in collaboration, and difficulties in auditing and reporting. Users may also find it challenging to keep up with the evolving landscape of data protection laws and regulations, which can change frequently and vary by jurisdiction.

The inefficiencies in these scenarios also extend to system resources. Custom pipelines that iterate over multiple tables to invoke the classification API can be resource-intensive, especially when dealing with large datasets. Each classification process consumes computational power, and when these processes are not run in an optimized manner, it can lead to redundant use of resources. This not only increases operational costs but also can slow down other processes that share the same infrastructure.

Aspects of the present disclosure include systems, methods, and devices to address, among other problems, the aforementioned shortcomings of conventional data platforms by intelligently triggering classification of data and providing a unique approach to allow customers to define rules for when the classifications are triggered. The disclosed techniques access an automatic classification profile comprising one or more conditions for triggering data classification and access a classification scope that identifies one or more tables to be classified. The disclosed techniques determine that a set of attributes of the one or more tables identified by the classification scope corresponds to the one or more conditions of the automatic classification profile. The disclosed techniques, in response to determining that the set of attributes of the one or more tables identified by the classification scope corresponds to the one or more conditions of the automatic classification profile, automatically classify data stored in one or more columns of the one or more tables. This saves a great deal of time and effort, which improves the overall efficiency of the system. In some cases, automated classification, with the assistance of automated tagging enables a user to specify rules where, in addition to labeling specific columns based on a recommendation, can also classify/label the entire table based on a combination of semantic types (e.g., PII, PHI) being present in the columns

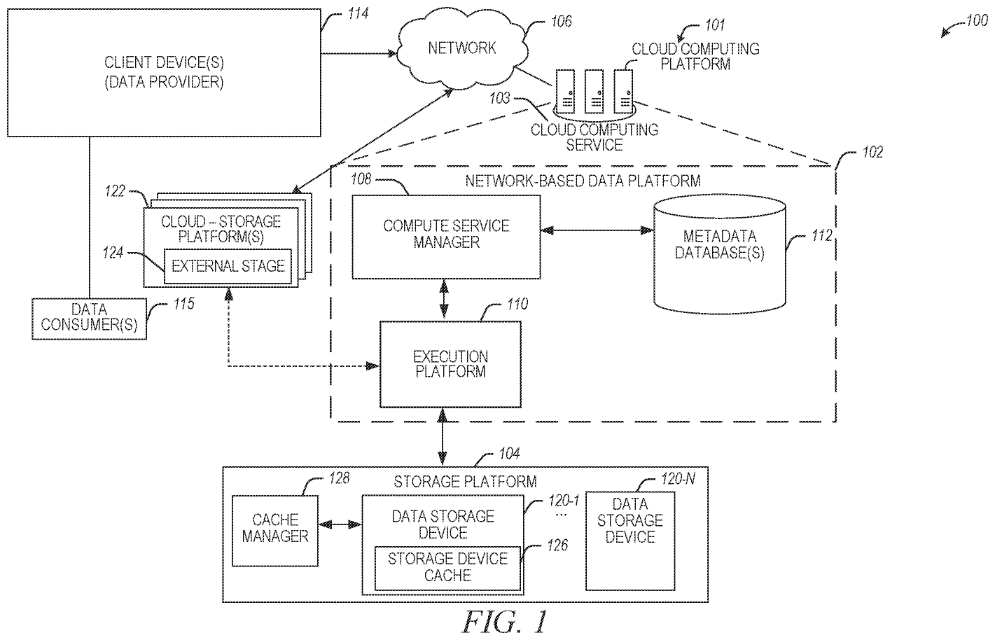

FIG. 1 illustrates an example computing environment 100 that includes a data platform in the example form of a network-based data platform 102, in accordance with some examples of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other examples, the computing environment may comprise another type of network-based database system or a cloud data platform. For example, in some aspects, the computing environment 100 may include a cloud computing platform 101 with the network-based data platform 102 and a storage platform 104 (also referred to as a cloud storage platform). The cloud computing platform 101 provides computing resources and storage resources that may be acquired (purchased) or leased and configured to execute applications and store data.

The cloud computing platform 101 may host a cloud computing service 103 that facilitates storage of data on the cloud computing platform 101 (e.g., data management and access) and analysis functions (e.g., structured query language (SQL) queries, analysis), as well as other processing capabilities (e.g., parallel execution of sub-plans, as described herein). The cloud computing platform 101 may include a three-tier architecture: data storage (e.g., storage platforms 104 and 122), an execution platform 110 (e.g., providing query processing), and a compute service manager 108 providing cloud services.

It is often the case that organizations that are customers of a given data platform also maintain data storage (e.g., a data lake) that is external to the data platform (e.g., one or more external storage locations). For example, a company could be a customer of a particular data platform and also separately maintain storage of any number of files (unstructured files, semi-structured files, structured files, and/or files of one or more other types) on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform. The techniques described in this disclosure pertain to non-volatile storage devices that are used for the internal storage location and/or the external storage location.

From the perspective of the network-based data platform 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location. For example, in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based data platform 102 of the cloud computing platform 101 is in communication with the cloud storage platforms 104 and 122 (e.g., Amazon Web Services (AWS)®, Microsoft Azure Blob Storage®, or Google Cloud Storage). The network-based data platform 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based data platform 102.

The network-based data platform 102 comprises a compute service manager 108, an execution platform 110, and one or more metadata databases 112. The network-based data platform 102 hosts and provides data reporting and analysis services to multiple client accounts.

The compute service manager 108 coordinates and manages operations of the network-based data platform 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the network-based data platform 102. A user may utilize the client device 114 to submit data storage, retrieval, and analysis requests to the compute service manager 108. Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices that may be used to access services provided by the cloud computing platform 101 (e.g., cloud computing service 103) by way of a network 106, such as the Internet or a private network.

In the description below, actions are ascribed to users, particularly

consumers and providers. Such actions shall be understood to be performed concerning client device (or devices) 114 operated by such users. For example, notification to a user may be understood to be a notification transmitted to client device 114, input or instruction from a user may be understood to be received by way of the client device 114, and interaction with an interface by a user shall be understood to be interaction with the interface on the client device 114 by a data consumer 115. In addition, database operations (joining, aggregating, analysis, inserting, deleting, updating, etc.) ascribed to a user (consumer or provider) shall be understood to include performing such actions by the cloud computing service 103 in response to an instruction from that user, such as using an SQL query or command.

Some database operations performed by the compute service manager 108 can include an operation to classify one or more columns of a table in a result or response to a query received from a client device 114. Specifically, the compute service manager 108 can receive a request to access or perform an operation on a table from the client device 114 by way of accessing a classification profile that includes one or more conditions for triggering data classification. The compute service manager 108 can determine that one or more attributes of a table, schema, database, or other data satisfies the one or more conditions. In response, the compute service manager 108 triggers automatic data classifications associated with one or more columns of the table. In response, the compute service manager 108 formulates a response to the query in which the one or more columns of data that are classified are returned in the results.

The compute service manager 108 is also coupled to one or more metadata databases 112 that store metadata about various functions and aspects associated with the network-based data platform 102 and its users. The metadata database 112 can store the table that provides the mapping between sessions, references to objects, identity of objects, and/or access privileges of the objects. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device. In some examples, metadata database 112 is configured to store account object metadata.

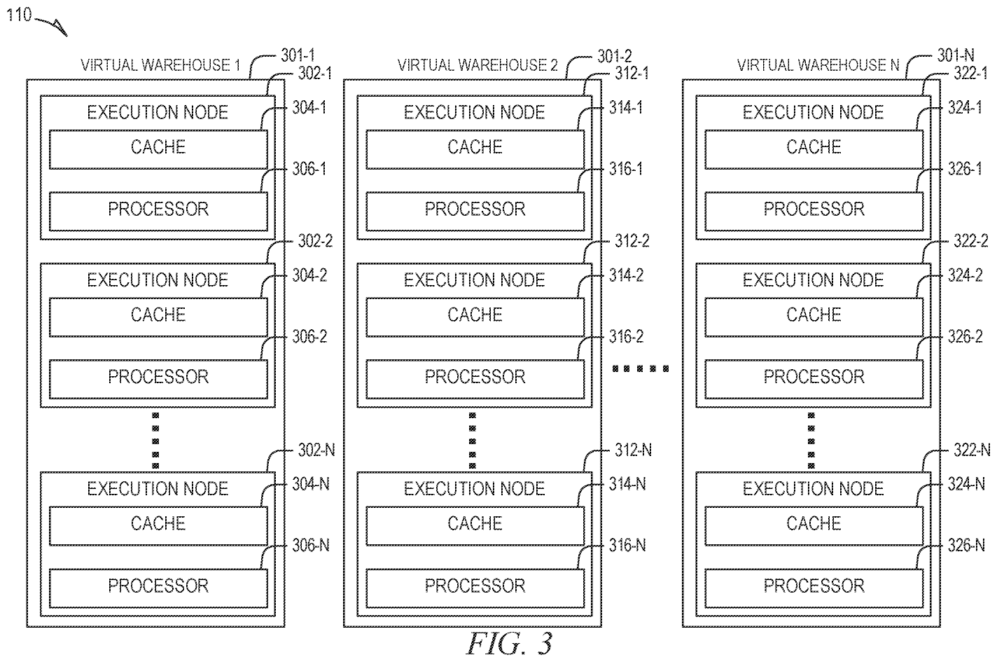

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud storage platforms 122. The storage platform 104 comprises multiple data storage devices 120-1 to 120-N. In some examples, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like.

In some examples, at least one storage device cache 126 (e.g., an internal cache) may reside on one or more of the data storage devices 120-1 to 120-N, and at least one external stage 124 may reside on one or more of the cloud storage platforms 122. In some examples, a single storage device cache 126 can be associated with all of the data storage devices 120-1 to 120-N so that the single storage device cache 126 is shared by and can store data associated with any one of the data storage devices 120-1 to 120-N. In some examples, each data storage device of storage devices 120-1 to 120-N can include or implement a separate storage device cache 126. A cache manager 128 handles the transfer of data from the data storage devices 120-1 to 120-N to the storage device cache 126. The cache manager 128 handles the eviction of data from the storage device cache 126 to the respective associated data storage devices 120-1 to 120-N. The storage platform 104 can include one or more hard drives and/or can represent a plurality of hard drives distributed on a plurality of servers in a cloud computing environment.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

The compute service manager 108, metadata database(s) 112, execution platform 110, and storage platform 104 are shown in FIG. 1 as individual discrete components. However, each of the compute service manager 108, metadata database(s) 112, execution platform 110, and storage platform 104 may be implemented as a distributed system (e.g., distributed across multiple systems/platforms at multiple geographic locations). Additionally, each of the compute service manager 108, metadata database(s) 112, execution platform 110, and storage platform 104 can be scaled up or down (independently of one another) depending on changes to the requests received and the changing needs of the network-based data platform 102. Thus, in the described examples, the network-based data platform 102 is dynamic and supports regular changes to meet the current data processing needs.

During a typical operation, the network-based data platform 102 processes multiple jobs (e.g., operators of sub-plans) determined by the compute service manager 108. These jobs (e.g., caller processes) are scheduled and managed by the compute service manager 108 to determine when and how to execute the job. For example, the compute service manager 108 may divide the job into multiple discrete tasks (e.g., caller processes) and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task (e.g., in a storage device cache 126, such as an HDD cache or random access memory (RAM)) and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

According to various examples, the execution platform 110 executes a query according to a query plan determined by the compute service manager 108. As part of executing the query, the execution platform performs a table scan in which one or more portions of a database table are scanned to identify data that matches the query. More specifically, the database table can be organized into a set of files where each file comprises a set of blocks (or records) and each block (or record) stores at least a portion of a column (or row) of the database. Each execution node provides multiple threads of execution, and in performing a table scan, multiple threads perform a parallel scan of the set of blocks (or records) of a file, which may be selected from a scan set corresponding to a subset of the set of files into which the database is organized. The query plan, in some cases, can include a request to organize data from a structured or unstructured text file into one or more tables.

The cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

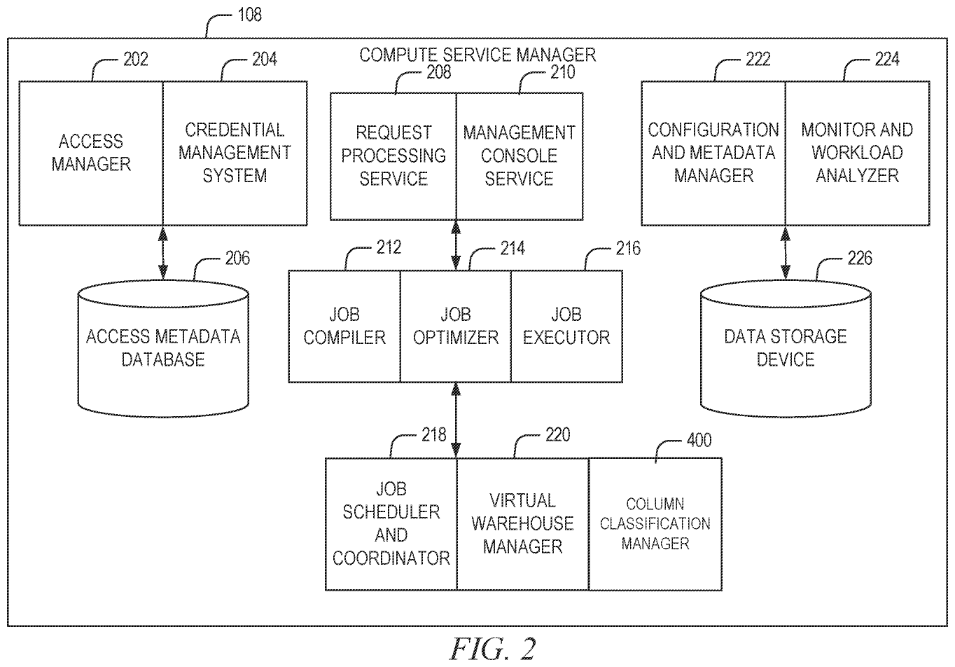

FIG. 2 is a block diagram illustrating components of the compute service manager 108, in accordance with some examples of the present disclosure. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates the use of remotely stored credentials to access external resources such as data resources in a remote storage device. As used herein, the remote storage devices may also be referred to as “persistent storage devices,” “non-volatile storage devices,” “cloud storage devices,” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110, in a storage device cache 126, or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an example, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries by one or more execution nodes of the execution platform 110. In some cases, the compute service manager 108 includes a column classification manager 400, discussed in more detail below, to handle jobs of the job executor 216.

Additionally, the compute service manager 108 includes a configuration and metadata manager 222, which manages the information related to the data stored in the remote data storage devices and the local buffers (e.g., the buffers in execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based data platform 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based data platform 102. For example, data storage device 226 may represent buffers in execution platform 110, storage devices in storage platform 104, or any other storage device.

FIG. 3 is a block diagram illustrating components of the execution platform 110, which can be implemented by any of the virtual warehouses of the execution platform 110, in accordance with some examples of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing data from any of the data storage devices 120-1 to 120-N and their associated storage device cache 126 (e.g., via a respective lock file) shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some examples, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some examples, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative examples may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the cloud storage platform 104. The techniques described with respect to the cache manager 128 of the storage platform 104 (e.g., an HDD) can be similarly applied to the cache 304-N, 314-N, and 324-N of the execution nodes 302-N, 312-N, and 322-N.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

In some examples, a heuristic can be maintained or generated in association with the execution platform 110. The heuristic can represent a size (e.g., number of virtual warehouses) to use to execute a given task or query (e.g., automatic data classification query or process), a time interval for executing the task or query, and/or other parameters to optimize cost and reduce processing times. This heuristic can be used to automate the selection of the number of warehouses used to execute an automatic data classification process and when to execute the process to reduce cost and increase throughout.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

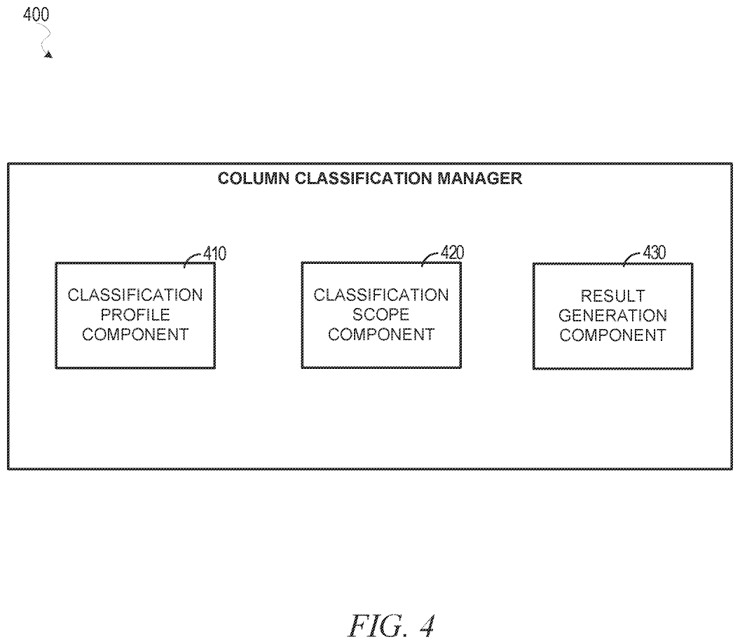

FIG. 4 is a block diagram illustrating an example of the column classification manager 400, which can be implemented by any of the virtual warehouses of the execution platform 110, such as the execution node 302-1, compute service manager 108, and/or the request processing service 208, in accordance with some examples. The column classification manager 400 can include a classification profile component 410, a classification scope component 420, and a result generation component 430. Below is a general discussion of the column classification manager 400 followed by a detailed description of operation of the individual components of the column classification manager 400.

Starting with the general discussion of the column classification manager 400, the column classification manager 400 is configured to access an automatic classification profile including one or more conditions for triggering data classification and access a classification scope that identifies one or more tables to be classified. In some cases, the column classification manager 400 determines a set of containers/assets to monitor using a defined classification profile. If the classification scope is a schema, the column classification manager 400 monitors all the tables in the schema to determine if the condition for automated re-classification or classification is met. If the scope is a database, the column classification manager 400 monitors all schemas in the database and its tables to determine if the condition for the database and its tables is met for automated re-classification or classification. determines the set of container/assets to monitor using the said classification profile.

The column classification manager 400 determines that a set of attributes of the one or more tables identified by the classification scope corresponds to the one or more conditions of the automatic classification profile, and in response, automatically classify data stored in one or more columns of the one or more tables. In some examples, the one or more conditions include at least one of an age of the one or more tables, a duration of time since the one or more tables have been previously classified, a minimum number of rows of the one or more tables, a data drift percentage of the one or more tables, a duration of time since a new column has been added to the one or more tables, one or more classification runtime parameters being met, one or more default settings being met.

In some cases, the column classification manager 400 determines that the one or more tables includes a new table that has not yet been classified and computes an age for the new table based on a difference between a creation time of the new table and a current time. The column classification manager 400 determines that the age transgresses an age threshold to determine that the set of attributes of the one or more tables identified by the classification scope corresponds to the one or more conditions of the automatic classification profile. In some cases, the column classification manager 400 obtains a time representing when the one or more tables have previously been classified and determines that the time transgresses a duration threshold to determine that the set of attributes of the one or more tables identified by the classification scope corresponds to the one or more conditions of the automatic classification profile.

In some examples, the column classification manager 400 determines a number of rows present in the one or more tables and determining that the number of rows transgresses a minimum number of rows threshold to determine that the set of attributes of the one or more tables identified by the classification scope corresponds to the one or more conditions of the automatic classification profile. The column classification manager 400 determines an increase percentage in a number of rows of the one or more tables and determines that the increase percentage in the number of rows transgresses threshold to determine that the set of attributes of the one or more tables identified by the classification scope corresponds to the one or more conditions of the automatic classification profile. In some cases, the column classification manager 400 determines that the one or more tables includes a new column and computes an age for the new column based on a difference between a creation time of the new column and a current time. The column classification manager 400 determines that the age transgresses an age threshold to determine that the set of attributes of the one or more tables identified by the classification scope corresponds to the one or more conditions of the automatic classification profile.

In some examples, the column classification manager 400 obtains one or more default settings and determines that the one or more default settings are currently met to determine that the set of attributes of the one or more tables identified by the classification scope corresponds to the one or more conditions of the automatic classification profile. In some cases, the column classification manager 400 generates a set of categories for the one or more columns of the one or more tables in response to automatically classifying the data stored in the one or more columns of the one or more tables.

The set of categories represents a type of data stored in one or more columns. In some cases, the column classification manager 400 accesses a map of tags representing sensitivity of data stored in the one or more tables. The column classification manager 400 determines that the set of categories for the one or more columns corresponds to the map of tags and in response to determining that the set of categories for the one or more columns corresponds to the map of tags, associates a tag with the one or more columns. In some cases, the column classification manager 400 restricts or masks data stored in the one or more columns in response to associating the tag with the one or more columns based on a defined masking policy.

In some cases, the map of tags is user defined or automatically generated. In some cases, a tag in the map of tags includes a plurality of categories, and the column classification manager 400 determines that the set of categories for the one or more columns corresponds to the map of tags by determining that the set of categories includes each tag in the plurality of categories. In some examples, a role of an account that creates the automatic classification profile excludes permissions to access data stored in the one or more tables. In such cases, the column classification manager 400 applies a global privilege to a process used to classify the data to enable the data stored in the one or more columns to be classified without exposing the data to the account. In some cases, the column classification manager 400 automatically selects a warehouse size and time for execution for automatically classifying the data based on one or more heuristics for maximizing throughput and minimizing cost of execution. In some cases, the column classification manager 400 determines that one or more categories generated in response to automatically classifying the data stored in the one or more columns of the one or more tables corresponds to a predefined semantic category.

In some examples, the column classification manager 400, in response to determining that the one or more categories generated in response to automatically classifying the data stored in the one or more columns of the one or more tables corresponds to a predefined semantic category, tags the one or more columns as at least one of an identifier, quasi-identifier, sensitive, and/or insensitive.

Continuing with reference to FIG. 4, below is a detailed discussion of the individual components of the column classification manager 400. Specifically, the classification profile component 410 accesses an automatic classification profile. The automatic classification profile includes one or more conditions for triggering data classification. The automatic classification profile can be specified by a user account, such as a user account having a certain role or permissions associated with a table, database, and/or schema of a plurality of tables. The automatic classification profile can allow a user to control when automatic classification of a set of tables is triggered or executed.

For example, the automatic classification profile can define or include one or more conditions. The conditions can include a new table classification age condition. This condition defines the earliest time to trigger automatic classification for a new table that has not been previously classified. The earliest time can be user defined or set by default, such as based on a number of days. The one or more conditions can include a classification age condition. The classification age condition can define a maximum duration of time since the last classification for enabling a table to become eligible for reclassification. The maximum duration of time can include a threshold that is user specified or set by default. When a duration of time has elapsed since a table has been last classified reaches the threshold, the column classification manager 400 can trigger automatic classification of the table, schema, and/or database.

The conditions can include a minimum rows condition. The minimum rows condition can specify a threshold number of minimum rows being present in a table for triggering automatic classification. The column classification manager 400 can periodically and/or continuously monitor the number of rows in a table, schema, and/or database. When that number reaches the minimum number of rows, the column classification manager 400 can trigger automatic classification of the table, schema, and/or database. The conditions can include a data drift percentage condition. The data drift percentage condition can specify a table becoming eligible for automatic re-classification when a growth or growth rate of the table or rows reaches a threshold growth rate since the last time the table was classified. For example, a first classification of the table can be performed when the table reaches 100 rows. The growth rate (or data drift) can be set to 20%. In such cases, when the column classification manager 400 determines that the number of rows has increased by 20% (e.g., the number of rows increased to 121 from 120, the column classification manager 400 can trigger automatic classification of the table, schema, and/or database.

The conditions can include a new column age condition. The new column age condition can define a threshold indicating or triggering automatic classification when a new column (that has never been classified before) reaches a certain age. This is the earliest time when a column in a table becomes eligible for initial classification or re-classification. A runtime options deep change detector can be used to automatically trigger automatic classification of the table, schema, and/or database based on certain runtime parameters changing by a threshold amount. For example, if a new custom category has been added to an automatic classification engine, the column classification manager 400 can trigger automatic classification of the table, schema, and/or database. Other default settings can be used to automatically trigger classification of the table, schema, and/or database.

Generating classifications, as described herein, refers to assigning one or more categories, semantic categories, and/or labels to columns to identify the type of data that is being stored by the entries of the column. A column can include multiple data or information from which features can be computed or generated, such data or information can include a column name and/or data entries. The features can represent the fraction of cells that contain strings with a specified pattern, a similarity between text in the column to English written text, and so forth.

In some examples, the classification scope component 420 accesses identifiers of a table, tables, schema, database or other data specified by the user via the client device 114, such as in a query. The classification scope component 420 can retrieve a set of conditions stored in association with the identified table, tables, schema, database or other data from the classification profile component 410. The classification scope component 420 can compare one or more attributes of the table, tables, schema, database or other data identified by the user account to a set of conditions stored by the classification profile component 410 for that user account. In response to determining that the attributes satisfy one or more or a combination of the conditions, the classification scope component 420 can trigger automatic classification of the entire database, table, tables, schema, database and/or other data. In some cases, the classification scope component 420 defines a set of assets to monitor continuously for detection of whether a condition for classification is met. A classification manager component can then (in response to the condition for classification being met) obtains the classification scope (e.g., schema) and classification profile and then analyzes the tables that are within the scope (that match the condition for classification or other associated tables) to determine if they are eligible based on the profile. In some cases, an additional component (not shown), such as a classification orchestrator can receive the classification profile and scope as input and monitors the tables for whether a condition for classification is met and schedules automated classification jobs.

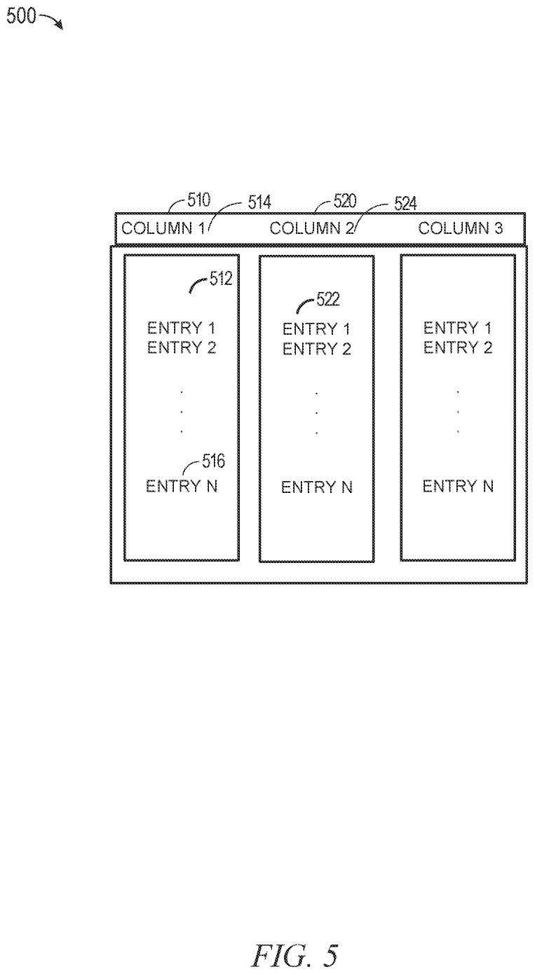

The classification scope component 420 obtains and/or accesses features of each column of the table and uses the rules and/or machine learning models of each category to generate confidence values for each entry or feature of each column of the table. Namely, as shown in FIG. 5, the classification scope component 420 (and/or the result generation component 430) can access a table 500. The classification scope component 420 can select a first column 510 from the table 500 which includes a column name 514 (e.g., a first feature) and one or more data entries 512-516 (e.g., a second feature). The classification scope component 420 applies the rules and/or machine learning models of each category to the features of the first column to generate a first set of confidence values for each feature (e.g., data entry and/or column name) of the first column. The classification scope component 420 again selects a second column 520 (which includes a column name 524 and one or more data entries 522) and applies the rules and/or machine learning models of each category to the features of the second column 520 to generate a first set of confidence values for each feature (e.g., data entry and/or column name) of the second column. Once all of the columns of the table 500 are processed in this manner, the classification profile component 410 outputs, for each of the plurality of categories, a list of confidence values for each feature of each column of the table. This output is provided to the result generation component 430. The result generation component 430 stores the target category in association with the first column 510. The result generation component 430 returns to the client device 114 the classification that includes the target category and performs one or more other operations on the table 500 based on the classification.

In some examples, the result generation component 430 can access a map of tags representing sensitivity of data stored in the one or more tables. The map can be defined by a user account/role and/or can be a default map. Each tag stored in the map can be associated with a single classification or category or a combination of classifications or categories. For example, any time a column is determined to be classified by the combination of classifications or categories, the corresponding tag stored in the map is also associated with the column. In some cases, certain collections of tags can be further classified using additional tags or sub-tags.

The result generation component 430 can determine that the set of categories for the one or more columns corresponds to the map of tags and, in response, associates a tag with the one or more columns. The result generation component 430 can restrict or mask data stored in the one or more columns in response to associating the tag with the one or more columns based on a defined masking policy. For example, the client device 114 can define a masking policy that causes or instructs the result generation component 430 (or other suitable component, such as a query execution component or process) to mask data or prevent access to data stored in one or more columns that are associated with certain tags or combination of tags.

In some examples, the result generation component 430 determines that a role of an account that created the automatic classification profile excludes permission for accessing data stored in the tables or databases identified by the classification scope component 420. In such cases, the result generation component 430 elevates permissions to enable classification to be performed for the tables or databases and prevents exposure of data stored in the tables or databases to the account. The result generation component 430 can enable the account to review the classifications and/or tags that are generated without presenting the underlying data that was analyzed to generate the classifications. In some cases, the privilege elevation can be performed by any other component mentioned above and below, such as a component used to classify the data.

In some examples, the result generation component 430 can access a heuristic associated with the virtual warehouses. The result generation component 430 can automatically select a warehouse size and time for execution (e.g., before classifying the columns) of automatically classifying the data based on one or more heuristics for maximizing throughput and minimizing cost of execution. For example, if there is no concern for processing time, the result generation component 430 can select a warehouse having a first size (e.g., extra small). If there are up to 100 columns in a table, the result generation component 430 can select a warehouse having a second size that is larger than the first size (e.g., small). If there are between 101 and 300 columns in the table, the result generation component 430 can select a warehouse having a third size that is larger than the second size. If there are over 301 columns in the table, the result generation component 430 can select a warehouse having a fourth size that is larger than the third size. The result generation component 430 can apply a trained machine learning model (e.g., a neural network) to predict the warehouse size to use given a column count and number of rows to be processed. Namely, the result generation component 430 can input the column count and number of rows to the machine learning model and receives a prediction from the machine learning model that represents a data warehouse size that balances cost and performance.

In some examples, the result generation component 430 determines that one or more categories generated in response to automatically classifying the data stored in the one or more columns of the one or more tables corresponds to a predefined semantic category. In such cases, the result generation component 430 can tag the one or more columns using privacy categories including as at least one of an identifier tag, quasi-identifier tag, sensitive tag, or insensitive tag. The identifier tag is indicative that attributes of the data uniquely identify an individual, such as by name, social security number, and/or phone number. These identifier tags are synonymous with direct identifiers. The quasi-identifier tag is indicative of attributes that uniquely identify an individual when two or more attributes are used in combination, such as age and gender. These quasi-identifier tags are synonymous with indirect identifiers. The sensitive tag is indicative of attributes that are not considered enough to identify an individual but correspond to private information, such as salary. The insensitive tag represents attributes that do not contain personal or sensitive information.

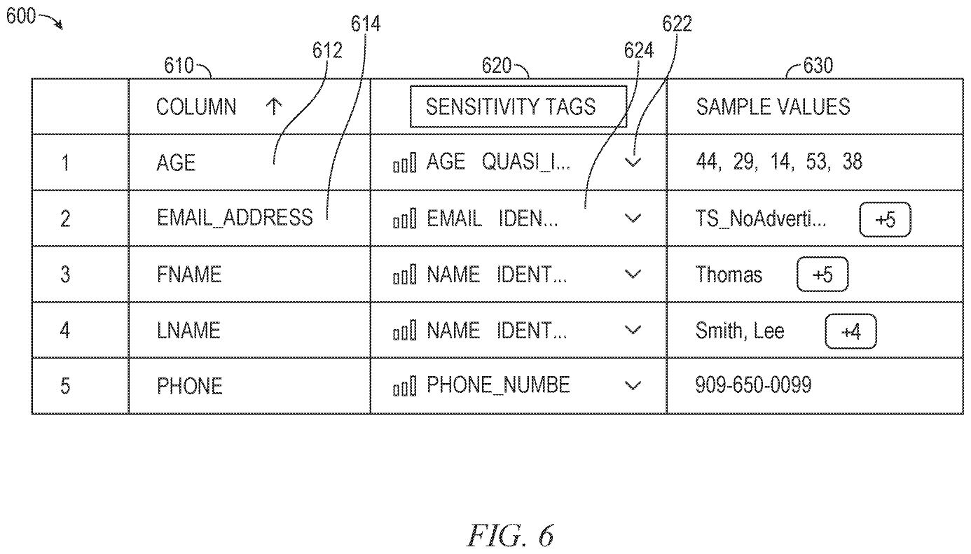

FIG. 6 is an illustrative output of the column classification manager 400, in accordance with some examples. For example, as shown in the user interface 600 of FIG. 6, the result generation component 430 can output a list of classifications 610. The list of classifications 610 represents different classifications or categories generated for each column or columns of a table, schema, and/or database of multiple tables. Each of the list of classifications 610 can be associated with one or more sensitivity tags 620 and one or more sample values 630 (e.g., if not masked) can be presented. For example, a first classification 612 can be presented as representing data stored in a first column of a table. The first classification 612 can be processed using a tag map to generate a first set of sensitivity tags 622 (e.g., a quasi-identifier tag). For example, a second classification 614 can be presented as representing data stored in a second column of a table. The second classification 614 can be processed using the tag map to generate a second set of sensitivity tags 624 (e.g., an identifier tag). The user interface 600 is interactive where user input can be received to select the first classification 612 to access the column. The first set of sensitivity tags 622 can be selected to view additional tags and/or set one or more masking policies to apply to the first column associated with the first classification 612.

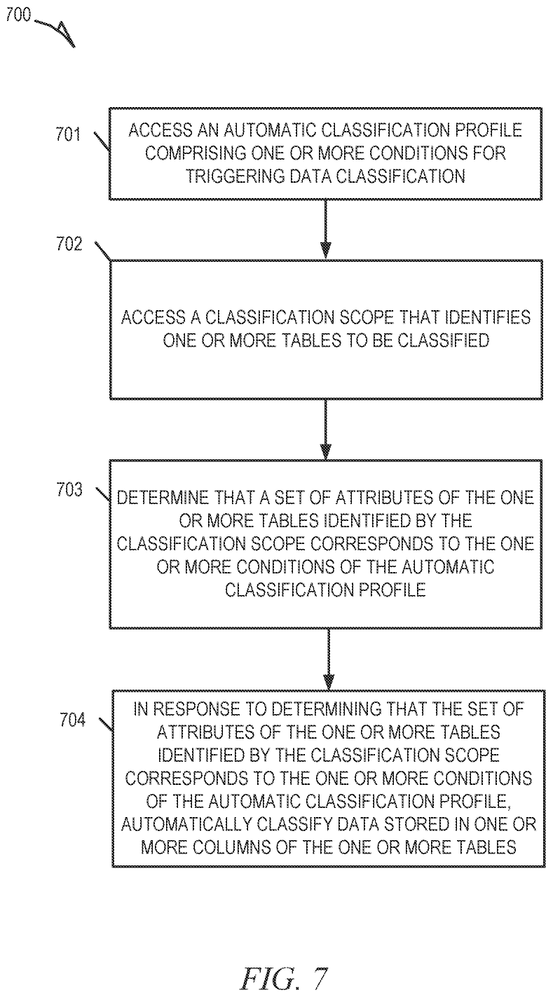

FIG. 7 is a flow diagram illustrating a method 700 of the column

classification manager 400, in accordance with some examples. The method 700 may be embodied in computer-readable instructions for execution by one or more hardware components (e.g., one or more processors) such that the operations of the method 700 may be performed by components of data platform 102 such as the execution platform 110. Accordingly, the method 700 are described below, by way of example with reference thereto. However, it shall be appreciated that method 700 may be deployed on various other hardware configurations and is not intended to be limited to deployment within the data platform 102. Depending on the example, an operation of the method 700 may be repeated in different ways or involve intervening operations not shown. Though the operations of the method 700 may be depicted and described in a certain order, the order in which the operations are performed may vary among examples, including performing certain operations in parallel or performing sets of operations in separate processes.

At operation 701, the column classification manager 400 accesses an automatic classification profile comprising one or more conditions for triggering data classification, as discussed above.

At operation 702, the column classification manager 400 accesses a classification scope that identifies one or more tables to be classified, as discussed above.

At operation 703, the column classification manager 400 determines that a set of attributes of the one or more tables identified by the classification scope corresponds to the one or more conditions of the automatic classification profile, as discussed above.

At operation 704, the column classification manager 400, in response to determining that the set of attributes of the one or more tables identified by the classification scope corresponds to the one or more conditions of the automatic classification profile, automatically classifies data stored in one or more columns of the one or more tables and selects a warehouse size that is of a suitable size automatically, as discussed above.

Described implementations of the subject matter can include one or more features, alone or in combination as illustrated below by way of example.

Example 1. A system comprising: at least one hardware processor; and at least one memory storing instructions that cause the at least one hardware processor to execute operations comprising: accessing an automatic classification profile comprising one or more conditions for triggering data classification; accessing a classification scope that identifies one or more tables to be classified; determining that a set of attributes of the one or more tables identified by the classification scope corresponds to the one or more conditions of the automatic classification profile; and in response to determining that the set of attributes of the one or more tables identified by the classification scope corresponds to the one or more conditions of the automatic classification profile, automatically classifying data stored in one or more columns of the one or more tables.

Example 2. The system of Example 1, wherein the one or more conditions comprise at least one of an age of the one or more tables, a duration of time since the one or more tables have been previously classified, a minimum number of rows of the one or more tables, a data drift percentage of the one or more tables, a duration of time since a new column has been added to the one or more tables, one or more classification runtime parameters being met, one or more default settings being met.

Example 3. The system of Example 2, wherein determining that the set of attributes of the one or more tables identified by the classification scope corresponds to the one or more conditions of the automatic classification profile comprises: determining that the one or more tables comprises a new table that has not yet been classified; computing an age for the new table based on a difference between a creation time of the new table and a current time; and determining that the age transgresses an age threshold to determine that the set of attributes of the one or more tables identified by the classification scope corresponds to the one or more conditions of the automatic classification profile.

Example 4. The system of any one of Examples 2-3, wherein determining that determining that the set of attributes of the one or more tables identified by the classification scope corresponds to the one or more conditions of the automatic classification profile comprises: obtaining a time representing when the one or more tables have previously been classified; and determining that the time transgresses a duration threshold to determine that the set of attributes of the one or more tables identified by the classification scope corresponds to the one or more conditions of the automatic classification profile.

Example 5. The system of any one of Examples 2-4, wherein determining that the set of attributes of the one or more tables identified by the classification scope corresponds to the one or more conditions of the automatic classification profile comprises: determining a number of rows present in the one or more tables; and determining that the number of rows transgresses a minimum number of rows threshold to determine that the set of attributes of the one or more tables identified by the classification scope corresponds to the one or more conditions of the automatic classification profile.

Example 6. The system of any one of Examples 2-5, wherein determining that the set of attributes of the one or more tables identified by the classification scope corresponds to the one or more conditions of the automatic classification profile comprises: determining an increase percentage in a number of rows of the one or more tables; and determining that the increase percentage in the number of rows transgresses threshold to determine that the set of attributes of the one or more tables identified by the classification scope corresponds to the one or more conditions of the automatic classification profile.

Example 7. The system of any one of Examples 2-6, wherein determining that the set of attributes of the one or more tables identified by the classification scope corresponds to the one or more conditions of the automatic classification profile comprises: determining that the one or more tables comprises a new column; computing an age for the new column based on a difference between a creation time of the new column and a current time; and determining that the age transgresses an age threshold to determine that the set of attributes of the one or more tables identified by the classification scope corresponds to the one or more conditions of the automatic classification profile.

Example 8. The system of any one of Examples 2-7, wherein determining that the set of attributes of the one or more tables identified by the classification scope corresponds to the one or more conditions of the automatic classification profile comprises: obtaining one or more default settings; and determining that the one or more default settings are currently met to determine that the set of attributes of the one or more tables identified by the classification scope corresponds to the one or more conditions of the automatic classification profile.

Example 9. The system of any one of Examples 2-8, the operations comprising: generating a set of categories for the one or more columns of the one or more tables in response to automatically classifying the data stored in the one or more columns of the one or more tables.

Example 10. The system of Example 9, wherein the set of categories represents a type of data stored in the one or more columns.

Example 11. The system of any one of Examples 9-10, the operations comprising: accessing a map of tags representing sensitivity of data stored in the one or more tables; determining that the set of categories for the one or more columns corresponds to the map of tags; and in response to determining that the set of categories for the one or more columns corresponds to the map of tags, associating a tag with the one or more columns.

Example 12. The system of Example 11, the operations comprising: restricting or masking data stored in the one or more columns in response to associating the tag with the one or more columns based on a defined masking policy.

Example 13. The system of any one of Examples 11-12, wherein the map of tags is user defined or automatically generated.

Example 14. The system of any one of Examples 11-13, wherein a tag in the map of tags comprises a plurality of categories, and wherein determining that the set of categories for the one or more columns corresponds to the map of tags comprises determining that the set of categories includes each tag in the plurality of categories.

Example 15. The system of any one of Examples 1-14, wherein a role of an account that creates the automatic classification profile excludes permissions to access data stored in the one or more tables, comprising: applying a global privilege to a process used to classify the data to enable the data stored in the one or more columns to be classified without exposing the data to the account.

Example 16. The system of any one of Examples 1-15, the operations comprising: automatically selecting a warehouse size and time for execution of automatically classifying the data based on one or more heuristics for maximizing throughput and minimizing cost of execution.

Example 17. The system of any one of Examples 1-16, the operations comprising: determining that one or more categories generated in response to automatically classifying the data stored in the one or more columns of the one or more tables corresponds to a predefined semantic category.

Example 18. The system of Example 17, the operations comprising: in response to determining that the one or more categories generated in response to automatically classifying the data stored in the one or more columns of the one or more tables corresponds to a predefined semantic category, tagging the one or more columns as at least one of an identifier, quasi-identifier, sensitive, or insensitive.

Example 19. A method comprising: accessing, by at least one hardware processor, an automatic classification profile comprising one or more conditions for triggering data classification; accessing a classification scope that identifies one or more tables to be classified; determining that a set of attributes of the one or more tables identified by the classification scope corresponds to the one or more conditions of the automatic classification profile; and in response to determining that the set of attributes of the one or more tables identified by the classification scope corresponds to the one or more conditions of the automatic classification profile, automatically classifying data stored in one or more columns of the one or more tables.

Example 20. A computer-storage medium comprising instructions that, when executed by at least one processor of a machine, configure the machine to perform operations comprising: accessing an automatic classification profile comprising one or more conditions for triggering data classification; accessing a classification scope that identifies one or more tables to be classified; determining that a set of attributes of the one or more tables identified by the classification scope corresponds to the one or more conditions of the automatic classification profile; and in response to determining that the set of attributes of the one or more tables identified by the classification scope corresponds to the one or more conditions of the automatic classification profile, automatically classifying data stored in one or more columns of the one or more tables.

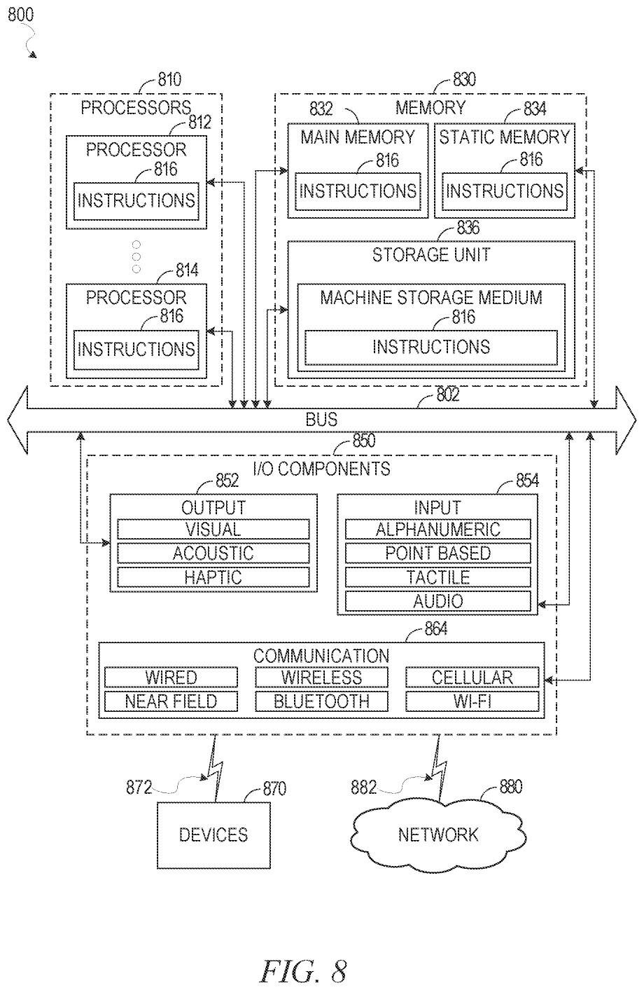

FIG. 8 illustrates a diagrammatic representation of a machine 800 in the form of a computer system within which a set of instructions may be executed for causing the machine 800 to perform any one or more of the methodologies discussed herein, according to an example. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute any one or more operations of the above processes (e.g., method 700). In this way, the instructions 816 transform a general, non-programmed machine into a particular machine 800 (e.g., the compute service manager 108 or one or more execution nodes of the execution platform 110) that is specially configured to carry out any one of the described and illustrated functions in the manner described herein.

In alternative examples, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 includes processors 810, memory 830, and input/output (I/O) components 850 configured to communicate with each other such as via a bus 802. In an example, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors (sometimes referred to as “cores”) that may execute instructions 816 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various examples, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, and other communication components to provide communication via other modalities. The devices 870 may be another machine or any of a wide variety of peripheral devices (e.g., a peripheral device coupled via a universal serial bus (USB)). For example, as noted above, the machine 800 may correspond to any one of the compute service manager 108, the execution platform 110, and the devices 870 may include any other computing device described herein as being in communication with the data platform 102.

The various memories (e.g., 830, 832, 834, and/or memory of the processor(s) 810 and/or the storage unit 836) may store one or more sets of instructions 816 and data structures (e.g., software) embodying or utilized by any one or more of the methodologies or functions described herein. These instructions 816, when executed by the processor(s) 810, cause various operations to implement the disclosed examples.

As used herein, the terms “machine-storage medium,” “device-storage medium,” and “computer-storage medium” mean the same thing and may be used interchangeably in this disclosure. The terms refer to a single or multiple transitory or non-transitory storage devices and/or media (e.g., a centralized or distributed database, and/or associated caches and servers) that store executable transitory or non-transitory instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the process or method 700 may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

1. A system comprising:
at least one hardware processor; and
at least one memory storing instructions that cause the at least one hardware processor to execute operations comprising:
receiving input from a user account that specifies one or more conditions for triggering data classification;
storing the input in an automatic classification profile;
accessing the automatic classification profile comprising the one or more conditions for triggering data classification;
accessing a classification scope that identifies one or more tables to be classified;
determining that a set of attributes of the one or more tables identified by the classification scope corresponds to the one or more conditions of the automatic classification profile specified by the input received from the user account; and
in response to determining that the set of attributes of the one or more tables identified by the classification scope corresponds to the one or more conditions of the automatic classification profile, automatically classifying data stored in one or more columns of the one or more tables.

2. The system of claim 1, wherein the one or more conditions comprise at least one of an age of the one or more tables, a duration of time since the one or more tables have been previously classified, a minimum number of rows of the one or more tables, a data drift percentage of the one or more tables, a duration of time since a new column has been added to the one or more tables, one or more classification runtime parameters being met, or one or more default settings being met.

3. The system of claim 1, wherein determining that the set of attributes of the one or more tables identified by the classification scope corresponds to the one or more conditions of the automatic classification profile comprises:
determining that the one or more tables comprises a new table that has not yet been classified;
computing an age for the new table based on a difference between a creation time of the new table and a current time; and
determining that the age for the new table transgresses an age threshold to determine that the set of attributes of the one or more tables identified by the classification scope corresponds to the one or more conditions of the automatic classification profile.

4. The system of claim 1, wherein determining that the set of attributes of the one or more tables identified by the classification scope corresponds to the one or more conditions of the automatic classification profile comprises:
obtaining a time representing when the one or more tables have previously been classified; and
determining that the time transgresses a duration threshold to determine that the set of attributes of the one or more tables identified by the classification scope corresponds to the one or more conditions of the automatic classification profile.

5. The system of claim 1, wherein determining that the set of attributes of the one or more tables identified by the classification scope corresponds to the one or more conditions of the automatic classification profile comprises:
determining a number of rows present in the one or more tables; and
determining that the number of rows transgresses a minimum number of rows threshold to determine that the set of attributes of the one or more tables identified by the classification scope corresponds to the one or more conditions of the automatic classification profile.

6. The system of claim 1, wherein determining that the set of attributes of the one or more tables identified by the classification scope corresponds to the one or more conditions of the automatic classification profile comprises:
determining an increase percentage in a number of rows of the one or more tables from a first point in time to a second point in time; and
determining that the increase percentage in the number of rows transgresses a threshold to determine that the set of attributes of the one or more tables identified by the classification scope corresponds to the one or more conditions of the automatic classification profile.

7. The system of claim 1, wherein determining that the set of attributes of the one or more tables identified by the classification scope corresponds to the one or more conditions of the automatic classification profile comprises:
determining that the one or more tables comprises a new column;
computing an age for the new column based on a difference between a creation time of the new column and a current time; and
determining that the age transgresses an age threshold to determine that the set of attributes of the one or more tables identified by the classification scope corresponds to the one or more conditions of the automatic classification profile.

8. The system of claim 1, wherein determining that the set of attributes of the one or more tables identified by the classification scope corresponds to the one or more conditions of the automatic classification profile comprises:
obtaining one or more default settings; and
determining that the one or more default settings are currently met to determine that the set of attributes of the one or more tables identified by the classification scope corresponds to the one or more conditions of the automatic classification profile.

9. The system of claim 1, the operations comprising:
generating a set of categories for the one or more columns of the one or more tables in response to automatically classifying the data stored in the one or more columns of the one or more tables.

10. The system of claim 9, wherein the set of categories represents a type of data stored in the one or more columns.

11. The system of claim 9, the operations comprising:
accessing a map of tags representing sensitivity of data stored in the one or more tables;
determining that the set of categories for the one or more columns corresponds to the map of tags; and
in response to determining that the set of categories for the one or more columns corresponds to the map of tags, associating a tag with the one or more columns.

12. The system of claim 11, the operations comprising:
restricting or masking data stored in the one or more columns in response to associating the tag with the one or more columns based on a defined masking policy.

13. The system of claim 11, wherein the map of tags is user defined or automatically generated.

14. The system of claim 11, wherein a tag in the map of tags comprises a plurality of categories, and wherein determining that the set of categories for the one or more columns corresponds to the map of tags comprises determining that the set of categories includes each tag in the plurality of categories.

15. The system of claim 1, wherein a role of an account that creates the automatic classification profile excludes permissions to access data stored in the one or more tables, comprising:
applying a global privilege to a process used to classify the data to enable the data stored in the one or more columns to be classified without exposing the data to the account.

16. The system of claim 1, the operations comprising:
automatically selecting a warehouse size and time for execution of automatically classifying the data based on one or more heuristics for maximizing throughput and minimizing cost of execution.

17. The system of claim 1, the operations comprising:
determining that one or more categories generated in response to automatically classifying the data stored in the one or more columns of the one or more tables corresponds to a predefined semantic category.

18. The system of claim 17, the operations comprising:
in response to determining that the one or more categories generated in response to automatically classifying the data stored in the one or more columns of the one or more tables corresponds to the predefined semantic category, tagging the one or more columns as at least one of an identifier, quasi-identifier, sensitive, or insensitive.

19. A method comprising:
receiving input from a user account that specifies one or more conditions for triggering data classification;
storing the input in an automatic classification profile;
accessing, by at least one hardware processor, the automatic classification profile comprising the one or more conditions for triggering data classification;
accessing a classification scope that identifies one or more tables to be classified;
determining that a set of attributes of the one or more tables identified by the classification scope corresponds to the one or more conditions of the automatic classification profile specified by the input received from the user account; and
in response to determining that the set of attributes of the one or more tables identified by the classification scope corresponds to the one or more conditions of the automatic classification profile, automatically classifying data stored in one or more columns of the one or more tables.

20. A computer-storage medium comprising instructions that, when executed by at least one processor of a machine, configure the machine to perform operations comprising:
receiving input from a user account that specifies one or more conditions for triggering data classification;
storing the input in an automatic classification profile;
accessing the automatic classification profile comprising the one or more conditions for triggering data classification;
accessing a classification scope that identifies one or more tables to be classified;
determining that a set of attributes of the one or more tables identified by the classification scope corresponds to the one or more conditions of the automatic classification profile specified by the input received from the user account; and
in response to determining that the set of attributes of the one or more tables identified by the classification scope corresponds to the one or more conditions of the automatic classification profile, automatically classifying data stored in one or more columns of the one or more tables.
